(19) United States
(12) Patent Application Publication
(10) Pub. No.: US 2004/0046776 A1
(43) Pub. Date: Mar. 11, 2004

(54) Object viewer editor control

(75) Inventors: Dianne Smith Phillips, Bow, NH (US); Siggi Pfundt, Munich (DE); Chris C. Yanchar, Hooksett, NH (US)

Correspondence Address: GATES & COOPER LLP, HOWARD HUGHES CENTER, 6701 CENTER DRIVE WEST, SUITE 1050, LOS ANGELES, CA, 90045, US

(73) Assignee: Autodesk, Inc.

(21) Appl. No.: 10/656,015

(22) Filed: Sep. 5, 2003

Related U.S. Application Data
(60) Provisional application No. 60/408,989, filed on Sep. 6, 2002.
(60) Provisional application No. 60/409,012, filed on Sep. 6, 2002.

(51) Int. Cl. G09G 5/00

(52) U.S. Cl. 345/700

(57) ABSTRACT

A method, apparatus, and article of manufacture provide the ability to display a graphical illustration of an object in a computer graphics program. An object is first obtained in the computer graphics program. A properties palette for the object is then displayed. The properties palette provides one or more object properties having corresponding property values. A graphical illustration of the object is then displayed in the properties palette.

### CROSS-REFERENCE TO RELATED APPLICATIONS

This application claims the benefit under 35 U.S.C. Section 119(e) of the following co-pending and commonly-assigned U.S. provisional patent application(s), which is/are incorporated by reference herein:

U.S. Provisional Patent Application Serial No. 60/408,989, entitled “PROPERTIES PALETTE”, by Dianne Smith Phillips, Chris C. Yanchar, Siggi Pfundt, Chad Steven Ames, Paul Joseph McArdle, John Gilbert Beltran, and James W. Paquette, filed on Sep. 6, 2002, Attorney Docket No. 30566.254-US-P1.

U.S. Provisional Patent Application Serial No. 60/409,012, entitled “IN-PLACE EDITING”, by Prasanna Pandurang Shanbhag, Dianne Smith Phillips, and Chad Steven Ames, filed on Sep. 6, 2002, Attorney Docket No. 30566.253-US-P1.

### BACKGROUND OF THE INVENTION

1. Field of the Invention

The present invention relates generally to computer graphics programs, and in particular, to a method, apparatus, and article of manufacture for displaying objects and properties of such objects in a computer graphics program.

2. Description of the Related Art

The use of graphics programs such as Computer Aided Design (CAD) application programs is well known in the art. CAD drawings often have many components (referred to as objects) that together define the drawing. Such objects have various properties such as style, dimensions, locations, property set data, and other important characteristics of an object. Various windows or palettes may be used to create, define, and maintain such properties. However, the palette or window used to create, define, and maintain the properties fails to provide a graphical illustration of the object. Further, such a palette or window also fails to provide the capability for the properties to be easily referenced in a graphical illustration (referred to as a keynoted illustration). These problems may be better understood by describing prior art drawing programs, palettes, and object viewers.

Drawing Programs

CAD applications are often used to create drawings used in the architectural, engineering, and construction (AEC) industry. The drawings are often defined by a collection of one or more graphical elements (referred to as objects), such as lines, circles, polylines, text, or dimensions. For example, a collection of various lines may make up a door or window object. CAD programs may treat each object as a single element for creation, manipulation, and modification. Some CAD programs may also provide objects that are special entities with predefined behaviors and display characteristics. Thus, the objects in a CAD program may be object-oriented objects having various methods/behaviors and properties (including display characteristics).

Information relating to an object may be entered and defined in one or more properties of the object. For example, users may have the capability to enter information about the style, dimensions, location, schedule data, display information and/or other important characteristics of an object.

Object Properties

To edit and maintain an object and/or properties of the object, various methodologies may be available. For example, a properties window may provide a common “one stop” location where a user can manage object properties without having to use individual typed commands. Such a properties window may list the current settings for all object properties, and allow the properties to be viewed alphabetically or by category. To change a property, the property may be selected from the list and a new value may be selected or entered.

However, while a properties window may provide the ability to view and edit all of the properties of an object, the user does not have the ability/capability to view a drawing or graphical view of the object within the property window. Accordingly, the user does not have the ability to easily display a graphical representation of the object simultaneously with the properties. In this regard, the user lacks the ability to easily identify how and what properties may affect the graphical representation of a drawing.

Object Viewer

Object viewers may be used to provide a preview image or keynoted illustration of an object. In the prior art, such an object viewer is presented in a separate window/dialog from that where the properties may be viewed and edited. Accordingly, the user must undertake multiple actions to actually view a graphical representation of an object and the properties (i.e., multiple windows must be physically opened). Such a requirement and use of multiple actions/tasks is inconvenient and cumbersome.

Accordingly, what is needed is the capability to view an object's properties while simultaneously viewing a graphical representation of the object that may (or may not) be dynamically updated as the properties are changed.

### SUMMARY OF THE INVENTION

The prior art lacks the ability to view, edit, and maintain object properties while simultaneously viewing a graphical illustration of the object.

One or more embodiments of the invention provide a graphical illustration that is inserted into a nested property tree as a control. The user can toggle the visibility of a keynoted illustration using a show/hide illustration button within a property tree. In addition, the properties in the tree may be keynoted to refer to the graphical illustration.

### BRIEF DESCRIPTION OF THE DRAWINGS

Referring now to the drawings in which like reference numbers represent corresponding parts throughout:

FIG. 1 is an exemplary hardware environment used to implement one or more embodiments of the invention;

FIG. 2 is a block diagram that illustrates the components of a graphics program in accordance with one or more embodiments of the invention;

FIG. 3 is a block diagram that illustrates the structure of an object list maintained by a 3D database in accordance with one or more embodiments of the invention;

FIG. 4 illustrates the various elements of a properties palette/tree in accordance with one or more embodiments of the invention;

FIG. 5 illustrates the shortcut menu of an object viewer available in accordance with one or more embodiments of the invention;

FIG. 6 illustrates an enlarged version of two dialog launch controls in accordance with one or more embodiments of the invention;

FIG. 7 is a flow chart that illustrates the use of the keynoted illustration editor control in accordance with one or more embodiments of the invention;

FIG. 8 illustrates the interaction between the pick two points control, the drawing, and the property tree in accordance with one or more embodiments of the invention;

FIG. 9 illustrates a dialog having two command buttons 902 in accordance with one or more embodiments of the invention; and

FIG. 10 illustrates some examples of the usage of an extended combobox in accordance with one or more embodiments of the invention.

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

Hardware Environment

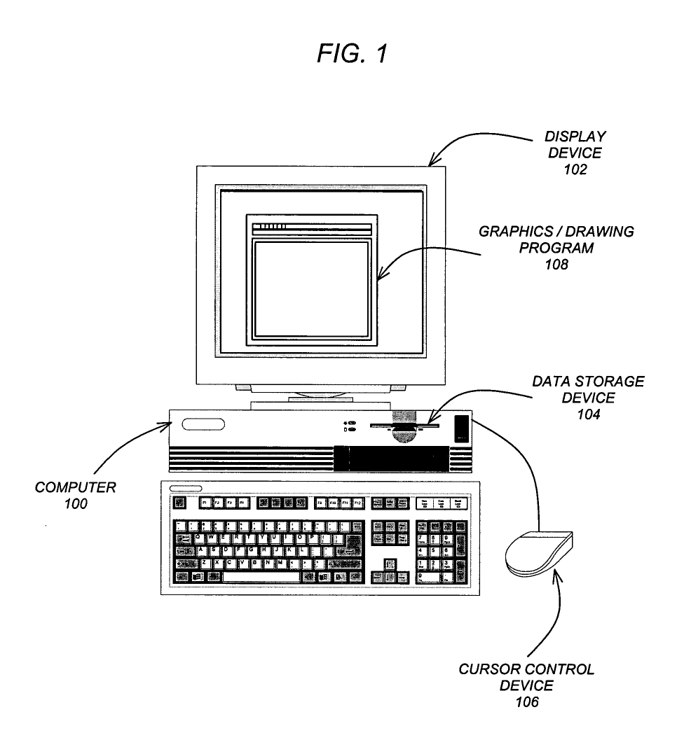

FIG. 1 is an exemplary hardware environment used to implement one or more embodiments of the invention. Embodiments of the invention are typically implemented using a computer 100, which generally includes a display device 102, data storage devices 104, cursor control devices 106, and other devices. Those skilled in the art will recognize that any combination of the above components, or any number of different components, peripherals, and other devices, may be used with the computer 100.

One or more embodiments of the invention are implemented by a computer-implemented graphics program 108 (e.g., a computer-aided design [CAD] program), wherein the graphics program 108 is represented by a window displayed on the display device 102. Generally, the graphics program 108 comprises logic and/or data embodied in or readable from a device, media, carrier, or signal, e.g., one or more fixed and/or removable data storage devices 104 connected directly or indirectly to the computer 100, one or more remote devices coupled to the computer 100 via a data communications device, etc.

Those skilled in the art will recognize that the exemplary environment illustrated in FIG. 1 is not intended to limit the present invention. Indeed, those skilled in the art will recognize that other alternative environments may be used without departing from the scope of the present invention.

Software Embodiments

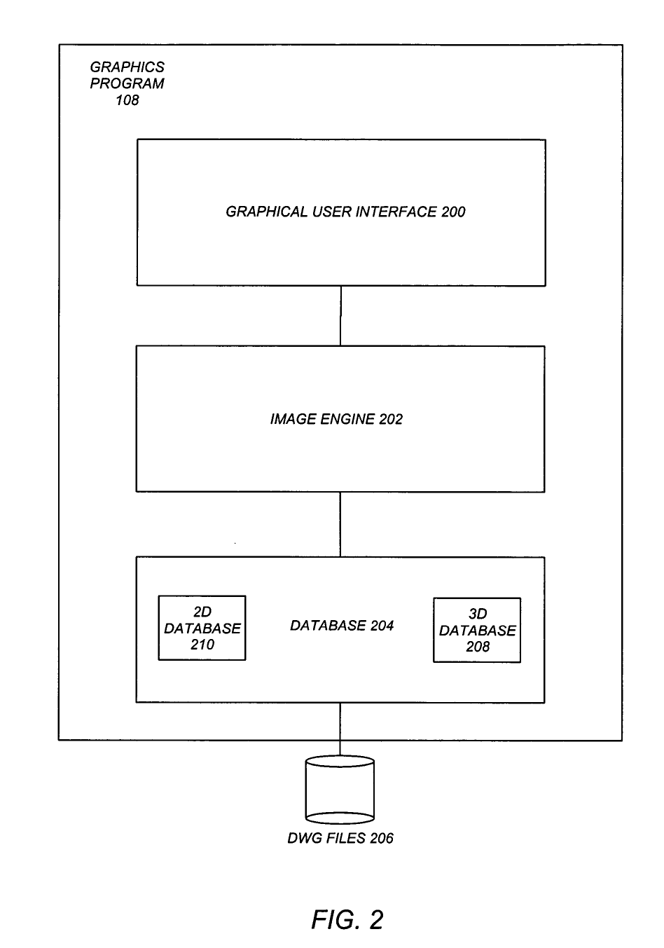

FIG. 2 is a block diagram that illustrates the components of the graphics program 108 in accordance with one or more embodiments of the invention. There are three main components to the graphics program 108, including: a Graphical User Interface (GUI) 200, an Image Engine (IME) 202, and a DataBase (DB) 204 for storing objects in Drawing (DWG) files 206.

The Graphical User Interface 200 displays information to the operator and provides the functionality for the operator's interaction with the graphics program 108.

The Image Engine 202 processes the DWG files 206 and delivers the resulting graphics to the monitor 102 for display. In one or more embodiments, the Image Engine 202 provides a complete application programming interface (API) that allows other computer programs to interface to the graphics program 108 as needed.

The Database 204 is comprised of two separate types of databases: (1) a 3D database 208 known as the “3D world space” that stores 3D information; and (2) one or more 2D databases 210 known as the “2D view ports” that stores 2D information derived from the 3D information.

Object List

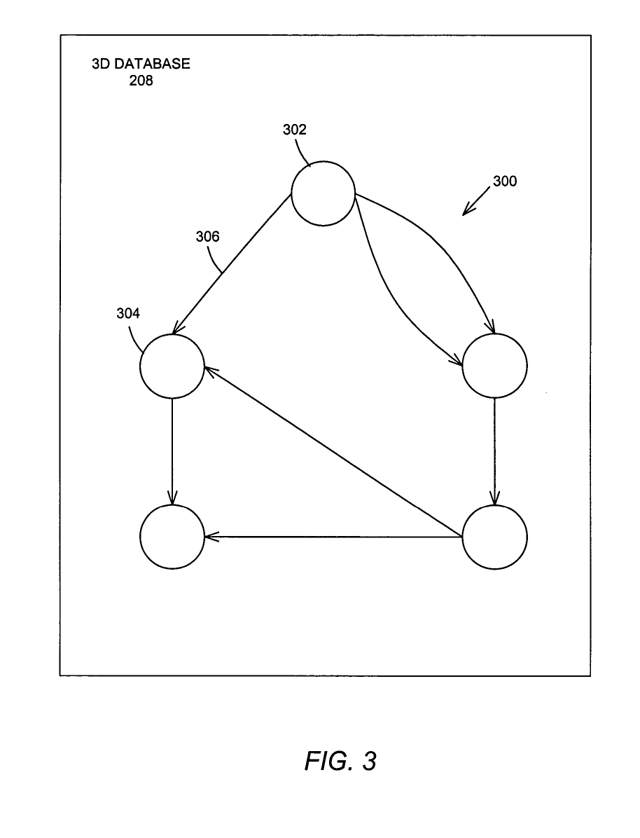

FIG. 3 is a block diagram that illustrates the structure of an object list 300 maintained by the 3D databases 208 in accordance with one or more embodiments of the invention. The object list 300 is usually comprised of a doubly-linked list having a list head 302 and one or more objects 304 interconnected by edges 306, although other structures may be used as well. There may be any number of different object lists 300 maintained by the 3D databases 208. Moreover, an object 304 may be a member of multiple object lists 300 in the 3D databases 208.

Properties Palette

One or more embodiments of the invention enable the use of a properties palette that provides a central location to enter and change the properties of an object. Using the palette, a user may enter information about the style, dimensions, location, property set data, and other important characteristics of an object.

A properties tree is the heart of the properties palette. A property tree is a mechanism by which data for and about objects are displayed and manipulated. While property trees may have been used in the prior art, they are normally presented with a single level of nesting. Two columns are often used with one column containing the property name and the second column containing the value for that property.

While still maintaining the two-column appearance where the property name is in the left column and the property value is in the right column, embodiments of the invention may provide a nested property tree that allows for nesting of the properties into new categories under the root nodes. Such an embodiment may also vary from prior art trees in that the nested tree may use color rather than alignment to indicate the child-parent relationship between the root node of a tree and a child category under it.

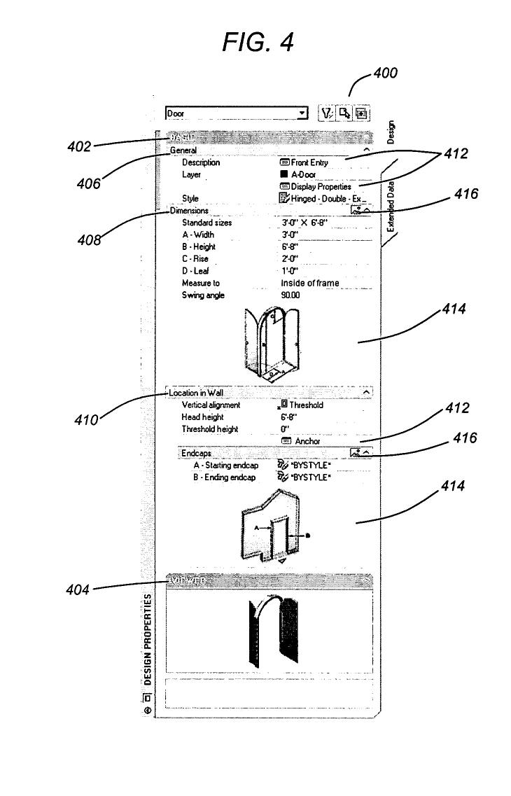

FIG. 4 illustrates the various elements of a properties palette/tree 400 in accordance with one or more embodiments of the invention. A category is a root level node in the properties tree 400. Categories are used to organize the properties in the palette 400 into major, related groups. Categories often contains at least two subcategories, but may contain less if necessary. For example, for any given object, there are often three categories into which all properties may be organized: BASIC, ADVANCED, and VIEWER.

As illustrated in FIG. 4, there are two root/category nodes: BASIC 402 and VIEWER 404. The BASIC category 402 contains properties and sub-categories that show the most commonly used properties. At a minimum, these properties may include data that may be added and/or modified using other dialogs within the graphics program108. Further, the BASIC category 402 may hold the properties that the user needs to access most often.

Subcategories are nodes under categories (e.g., under categories 402 and 404) that may contain properties or nest sub-categories. Generally, the subcategories may correspond to tabs of properties dialogs. In FIG. 4, the BASIC category 402 has three children: General 406, Dimensions 408, and Location 410, each of which in turn has several properties. The General subcategory 406 may contain object name, description, layer, display property access, style, and/or shape. While the ordering may be set, (e.g., the order above may be required to be followed), the categories, subcategories, and properties may be presented in a user specified or an alternative ordering scheme.

The Dimensions subcategory 408 usually contains specific geometric properties such as height, length, and width.

A Location subcategory 410 often contains anchor information. Further, the name of the location subcategory 410 may change depending upon the type of anchor (e.g., an Opening, Window, Door, or Window Assembly may display “Location in Wall” if inserted in a wall or “Location in Curtain Wall” if inserted in a curtain wall).

The VIEWER category 404 may contain a standard object viewer, with no additional sub-categories. While the prior art may provide for the inclusion of a preview image of an object in a separate window or dialog, the object viewer 404 editor control allows the viewer 404 to be inserted into the property tree 400 similar to other properties. In addition, the viewer 404 may be easily collapsed or expanded. Basically, the viewer 404 may comprise an object viewer embedded in the palette 400 as a special ActiveX control. The viewer node 404 has a single property that has no property name per se, but rather is an object viewer that displays a sample that indicates what the object would look like based on the data values of other items in the tree. In general, if an object has meaningful graphics and will not be a performance problem, then an image of the object may be displayed in the object viewer 404 portion of the palette.

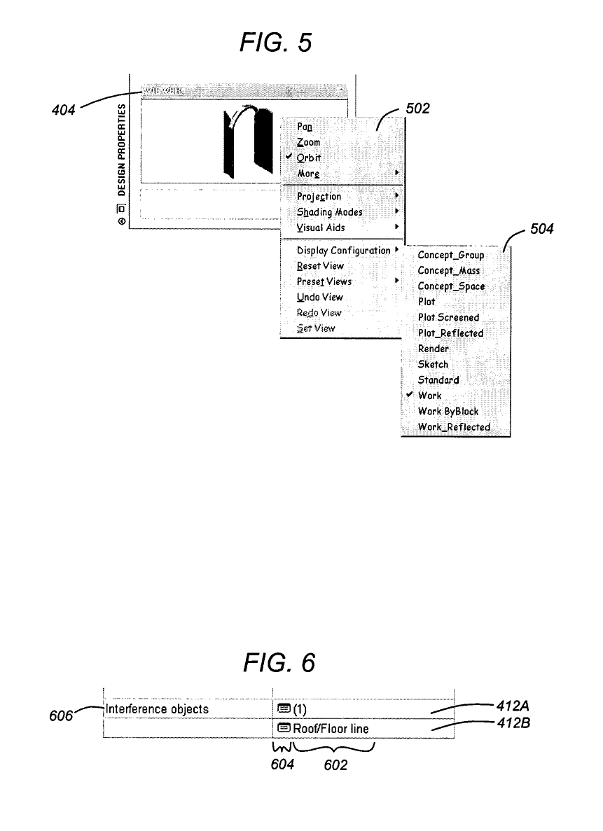

A shortcut menu of the viewer 404 may provide the ability to access various drawing manipulation functions. FIG. 5 illustrates the shortcut menu 502 of the object viewer available in accordance with one or more embodiments of the invention. As illustrated, the shortcut menu may also contain a selection flyout 504 for the display configuration. The flyout menu 504 provides a display configuration menu pick that contains the display configurations that are present in the current drawing. Further, the display configuration for the currently active view may be checked.

Referring back to FIG. 4, as described above, categories and subcategories may also contain nested subcategories. Nested subcategories provide the possibility to further group properties of a specific sub-category. For example, nested subcategories may be used for:

The X and Y axis properties for Ceiling Grids, Column Grids, and 2D Layout Grids

The X, Y, and Z axis properties for 3D Layout Grids

The lower and upper slope properties for Roofs

The slope properties for Slabs and Roof Slabs

The boundary condition properties for Space Boundaries

The endcap properties for Doors, Openings, Windows, and Window Assemblies that are anchored in a wall.

In addition to the above, a nested subcategory may be expanded and collapsed independently from its parent subcategory and other nested subcategories.

Dialog Launch Control

In addition to the above, the palette may provide the capability to invoke a worksheet for editing one or more property values. Such a capability is referred to as a dialog launch control. FIG. 4 illustrates the presence of various dialog launch controls 412. Enlarged versions of two dialog launch controls 412 are illustrated in FIG. 6. The dialog launch control 412 consists of a text value 602, plus the worksheet icon 604 to the left of the text 602. The control 412 may optionally have a property name 606. Both such configurations are depicted in FIG. 6. The first control 412A depicts the control 412A with a property name 606; the second control 412B is without a name. The text 602 in either column may be elided ( . . . ) if the text 602 cannot fit in the current column width. Further, a tool tip containing the full text may be displayed, as appropriate.

To select a property, a user may merely click the left (or right) mouse button. Alternatively, the user may double-click the left (or right) mouse button in the value column (text 602 and icon 604). Further, such a click or double-click operation may invoke the worksheet dialog. For keyboard access, the right arrow or the space bar may invoke the dialog (the <return> key may not be used in some embodiments since such an operation may advance the focus to the next row of the property tree 400). The entire control area (the property value column) may be the hotspot for activating this functionality.

Keynoted Illustration Editor Control

In addition to providing the ability to enter and change properties of an object (as described above), a control of the nested property tree 400 (i.e., the palette's categories or subcategories) may also provide keynoted illustrations 414. The palette 400 of FIG. 4 contains two keynoted illustrations 414—one for the dimensions node 408, and one for the endcaps node. A user may toggle the visibility of an illustration property editor 414 with the show/hide illustration button 416 on the category or subcategory item. Such a button expands or collapses the illustration image 414 of its associated sub-category.

The properties in the tree 400 can be keynoted to refer to the illustration 414. In FIG. 4, the width, height, rise, and leaf properties are keynoted to match the illustration 414. Accordingly, illustration images 414 may quickly indicate visually what a property pertains to in an object.

A keynoted illustration 414 may always be associated with a category, a subcategory or nested sub-category. An object may have multiple illustration images 414 for different categories or Sub-Categories. The images 414 may scale dynamically with the corresponding aspect ratio, if the width of the palette 400 is changed.

Generally, properties that do not pertain to the current settings may not be displayed. This in turn may affect the corresponding image. Accordingly, one or more embodiments of the invention may enable the availability of multiple illustrations for the same sub-category, dependent upon the currently visible properties that pertain to the image. In general the image and corresponding key letters reflect the current properties. For example, if a door does not have a rise or leaf property, then the corresponding image may not depict such properties

In addition to the above, the keynoted illustration 414 may provide for hover highlighting. In other words, if a particular property is selected, the corresponding key letter in the illustration 414 may be highlighted. Alternatively, if the cursor is placed over a particular property or key letter in the illustration 414, the key letter and/or corresponding property in the property tree may be highlighted.

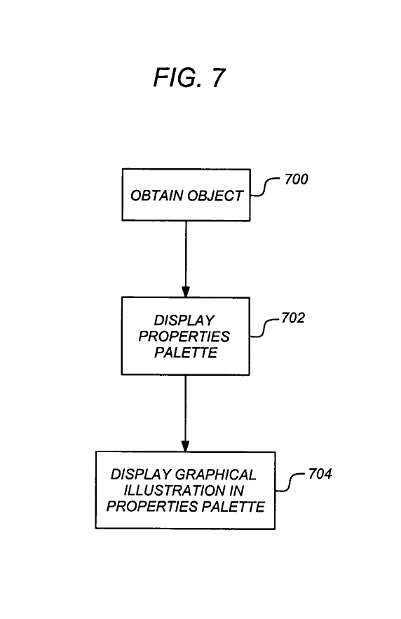

FIG. 7 is a flow chart that illustrates the use of the keynoted illustration editor control in accordance with one or more embodiments of the invention. At step 700, an object is obtained in a computer graphics program (e.g., a CAD program). As described above, the object may be equivalent to one or more graphical elements, such as lines, circles, polylines, text, or dimensions. The objects may also be special entities with predefined behaviors and display characteristics. Thus, the objects in a graphics program may be object-oriented objects having various methods/behaviors and properties (including display characteristics).

At step 702, a properties palette for the object is displayed. The properties palette has one or more object properties (e.g., in a first column) that have corresponding property values (e.g., in a second column). At step 704, a graphical illustration of the object is displayed in or as part of the properties palette. The visibility of the graphical illustration may be toggled using a show/hide illustration button.

The object properties may also be keynoted to refer to corresponding keynotes displayed in the graphical illustration. In this regard, the keynote displayed in the graphical illustration may be highlighted when the cursor is passed over the corresponding object property. Alternatively, one or more keynoted object properties may be highlighted in the properties list when the cursor is passed over the corresponding keynote or property displayed in the graphical illustration.

As an alternative (or in addition to) the keynoted graphical illustration and properties, the palette may be enabled with an object viewer (e.g., as part of an ActiveX application). The graphical view of the object may be changed merely by using a shortcut menu that provides various options (e.g., flyout options) as described above.

Pick Two Points Editor Control

In the prior art, a user was permitted to use a “pick point” button for any point value (e.g., (X,Y) position) in a drawing. In accordance with one or more embodiments of the invention, an ActiveX control used in the property tree 400 provides the ability to enter a distance value. The user may either type the value directly into the control, or select a button (e.g., that is immediately to the right of the edit control) to select two points on the actual drawing window, that is then converted into the correct distance by the program.

Thus, the user is able to use a “pick 2 points” button for any distance of a vertical. The user can click a “pick 2 points” button in a field, click two points on the drawing window to indicate a distance, and the distance will be recorded.

The control may have the behavior similar to other pickpoint controls. For example, an object may have a width property whose value is displayed in the properties palette 400 when the object is selected. The user may select the width property and the text field is active with the “pick 2 points” button next to it. The user may either type in a value or click the “pick 2 points” button. If the user clicks the “pick 2 points” button, the user is prompted to enter a start point and an end point via command line prompts (or pop-up dialogs). After entering the second point, the distance specified (i.e., the distance between the two points) may be entered as the new value for the width property. For cases when the user clicks anywhere outside of the drawing space while the pickpoint functionality is active, the action may cancel the pickpoint command and the value for the property may return to its previous value.

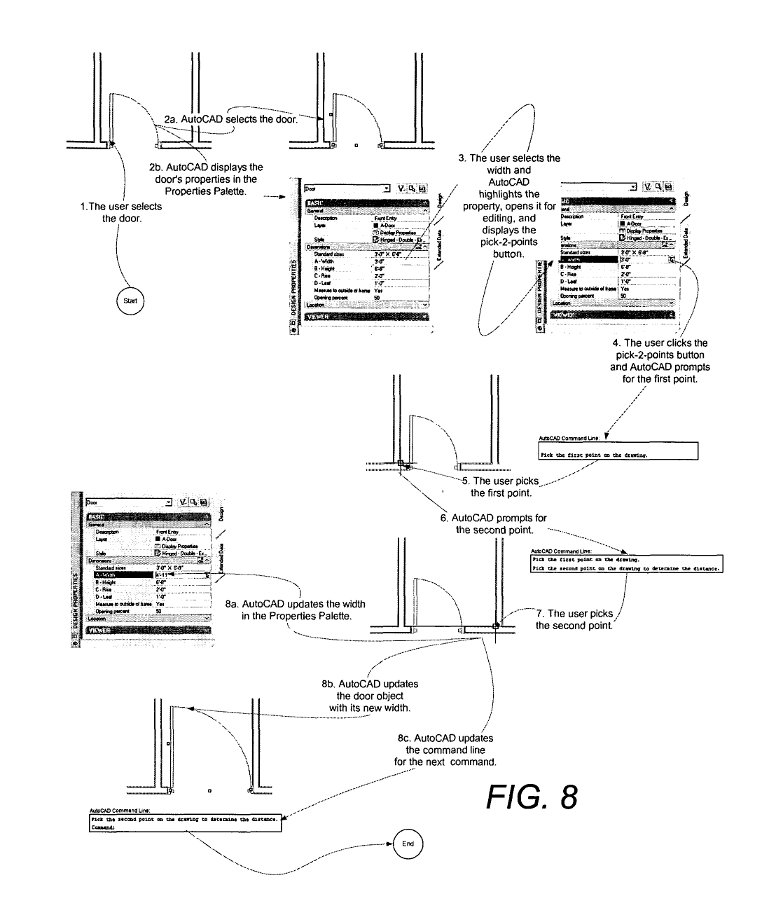

FIG. 8 illustrates the interaction between the pick two points control, the drawing, and the property tree.

Multi-Tab Properties Palette

Most property dialogs consist of a single property tree 400. One or more embodiments of the invention provide for the division of object properties across multiple tabs, as shown FIG. 4 (i.e., the Design tab and Extended Data tab). The contents of the second tab of the palette 400 depict additional properties in the same manner as the earlier figures.

Command Buttons

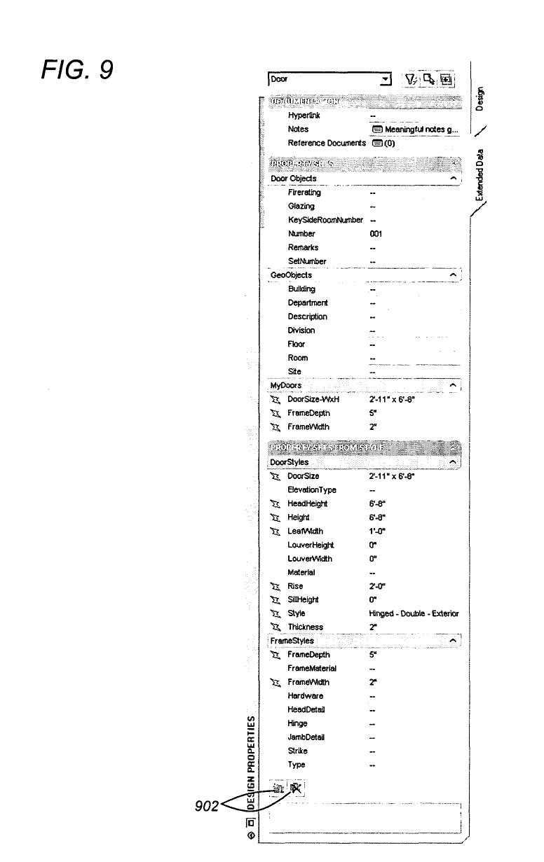

One or more embodiments of the invention also provide for the capability for properties or objects to add command buttons (e.g., comprised of image and/or text) to the properties palette 400. In FIG. 9, there are two command buttons 902 shown at the bottom of the dialog. The user can click these buttons 902 to invoke an action similar to how a user would click a pushbutton in a dialog. Further, the property provider and the content of the property tree 400 indicate whether or not these buttons 902 exist.

Properties Palette During Object Creation

The properties palette 400 may also be used during objection creation. The properties palette 400 may enable the use of new commands and a form of modeless dashboard dialogs that provides access to common properties used during these commands. Further, most (if not all) of the properties and commands may be available when modifying an object. Those properties that are only available during object creation may be marked with an ‘add’ icon.

Additional Sources of Property Content

Third party developers may have the ability to add properties to existing objects and to specify categories and sub-categories for such properties/objects. These third-party properties can be present during object creation, object editing, and tool editing through a generic framework.

Extended Combobox Editor Control

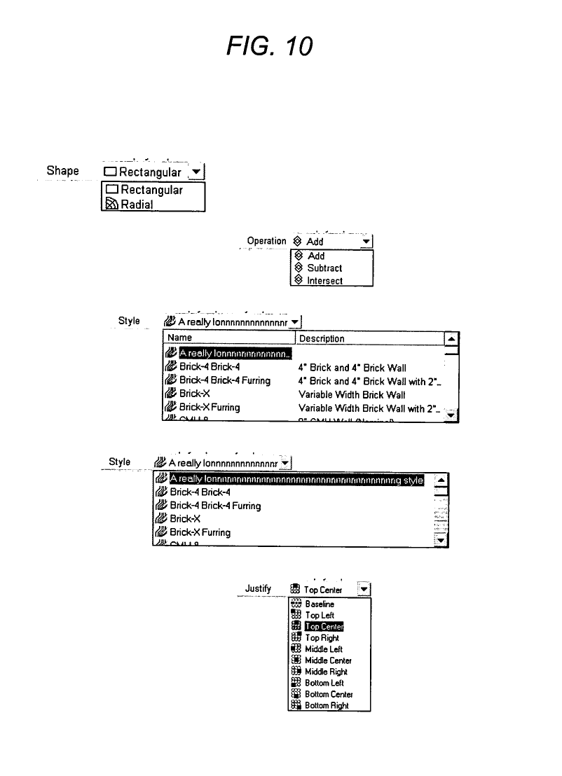

While the prior art may use extended combobox controls in dialogs and may use regular comboboxes in property trees, the present invention provides for the insertion of extended comboboxes in the venue of a property tree 400. Such extended comboboxes may be ActiveX edit controls that are used in the property tree 400 to enter (and/or select) a value from a fixed list of items (e.g., similar to a normal combobox wherein each item has an image associated with it). FIG. 10 illustrates some examples of the usage of an extended combobox in accordance with one or more embodiments of the invention.

Conclusion

This concludes the description of the preferred embodiment of the invention. The following describes some alternative embodiments for accomplishing the present invention. For example, any type of computer, such as a mainframe, minicomputer, or personal computer, or computer configuration, such as a timesharing mainframe, local area network, or standalone personal computer, could be used with the present invention.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A method for displaying a graphical illustration of an object in a computer graphics program, comprising:
obtaining an object in a computer graphics program;
displaying a properties palette for the object, wherein the properties palette comprises one or more object properties having corresponding property values;
displaying a graphical illustration of the object in the properties palette.

2. The method of claim 1, wherein one or more of the object properties are keynoted to refer to corresponding keynotes displayed in the graphical illustration.

3. The method of claim 2, further comprising highlighting the keynote displayed in the graphical illustration when the cursor is passed over the corresponding object property.

4. The method of claim 2, further comprising highlighting one or more keynoted object properties when the cursor is passed over the corresponding keynote or property displayed in the graphical illustration.

5. The method of claim 1, further comprising toggling the visibility of the illustration using a show/hide illustration button.

6. The method of claim 1, further comprising changing the view of the object displayed in the graphical illustration using a shortcut menu.

7. The method of claim 1, wherein the graphical illustration is enabled by an ActiveX application.

8. An apparatus for displaying a graphical illustration of an object in a computer graphics program of a computer system comprising:
(a) a computer having a memory;
(b) an application executing on the computer, wherein the application is configured to:
(i) obtain an object in a computer graphics program;
(ii) display a properties palette for the object, wherein the properties palette comprises one or more object properties having corresponding property values;
(iii) display a graphical illustration of the object in the properties palette.

9. The apparatus of claim 8, wherein one or more of the object properties are keynoted to refer to corresponding keynotes displayed in the graphical illustration.

10. The apparatus of claim 9, wherein the application is further configured to highlight the keynote displayed in the graphical illustration when the cursor is passed over the corresponding object property.

11. The apparatus of claim 9, wherein the application is further configured to highlight one or more keynoted object properties when the cursor is passed over the corresponding keynote or property displayed in the graphical illustration.

12. The apparatus of claim 8, wherein the application is further configured to toggle the visibility of the illustration using a show/hide illustration button.

13. The apparatus of claim 8, wherein the application is further configured to change the view of the object displayed in the graphical illustration using a shortcut menu.

14. The apparatus of claim 8, wherein the graphical illustration is enabled by an ActiveX application.

15. An article of manufacture comprising a program storage medium readable by a computer and embodying one or more instructions executable by the computer to perform a method for displaying a graphical illustration of an object in an object-oriented computer graphics system, the apparatus comprising:
means for obtaining an object in a computer graphics program;
means for displaying a properties palette for the object, wherein the properties palette comprises one or more object properties having corresponding property values;
means for displaying a graphical illustration of the object in the properties palette.

16. The article of manufacture of claim 15, wherein one or more of the object properties are keynoted to refer to corresponding keynotes displayed in the graphical illustration.

17. The article of manufacture of claim 16, further comprising means for highlighting the keynote displayed in the graphical illustration when the cursor is passed over the corresponding object property.

18. The article of manufacture of claim 16, further comprising means for highlighting one or more keynoted object properties when the cursor is passed over the corresponding keynote or property displayed in the graphical illustration.

19. The article of manufacture of claim 15, further comprising means for toggling the visibility of the illustration using a show/hide illustration button.

20. The article of manufacture of claim 15, further comprising means for changing the view of the object displayed in the graphical illustration using a shortcut menu.

21. The article of manufacture of claim 15, wherein the graphical illustration is enabled by an ActiveX application.
